(19) United States
(12) Patent Application Publication
(10) Pub. No.: US 2007/0127885 A1
(43) Pub. Date: Jun. 7, 2007

(54) Recording medium and method and apparatus for reproducing and recording text subtitle streams

(76) Inventors: Kang Soo Seo, Anyang-si (KR); Jea Yong Yoo, Seoul (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 11/602,970

(22) Filed: Nov. 22, 2006

Related U.S. Application Data
(63) Continuation of application No. 11/028,530, filed on Jan. 5, 2005.
(60) Provisional application No. 60/542,850, filed on Feb. 10, 2004.
(60) Provisional application No. 60/542,852, filed on Feb. 10, 2004.
(60) Provisional application No. 60/543,328, filed on Feb. 11, 2004.
(60) Provisional application No. 60/547,183, filed on Feb. 25, 2004.

(30) Foreign Application Priority Data
Jan. 6, 2004 (KR) 10-2004-0000633
Mar. 23, 2004 (KR) 10-2004-0019739

(51) Int. Cl. H04N 7/00

(52) U.S. Cl. 386/95

(57) ABSTRACT

A recording medium and method and apparatus for reproducing and recording text subtitle streams are disclosed. The text subtitle stream includes a dialog style segment defining a set of region styles and at least one dialog presentation segment. Each dialog style segment contains at least one region of dialog text, where each region of dialog text includes link information configured to link each region of dialog text to one of the set of region styles defined in the dialog style segment. For example, the link information is a region style identification which uniquely identifies the region style linked to each region of dialog text. When each region of dialog text is reproduced, the region style identified by the region style identification is applied.

### PRIORITY INFORMATION

This is a continuation application of application Ser. No. 11/028,530 filed Jan. 5, 2005, the entire contents of which are hereby incorporated by reference.

This application claims the benefit of U.S. Provisional Application No. 60/542,850, filed on Feb. 10, 2004; U.S. Provisional Application No. 60/542,852, filed on Feb. 10, 2004; U.S. Provisional Application No. 60/543,328, filed on Feb. 11, 2004, and U.S. Provisional Application No. 60/547,183, filed on Feb. 25, 2004, the entire contents of which are hereby incorporated by reference. This application also claims the benefit of Korean Patent Application No. 10-2004-0000633, filed on Jan. 6, 2004; and, Korean Patent Application No. 10-2004-0019739, filed on Mar. 23, 2004, which are hereby incorporated by reference as if fully set forth herein.

### BACKGROUND OF THE INVENTION

1. Field of the Invention

The present invention relates to a recording medium, and more particularly, to a recording medium and method and apparatus for reproducing and recording text subtitle streams. Although the present invention is suitable for a wide scope of applications, it is particularly suitable for recording the text subtitle stream file within the recording medium and effectively reproducing the recorded text subtitle stream.

2. Description of the Related Art

Optical discs are widely used as an optical recording medium for recording mass data. Presently, among a wide range of optical discs, a new high-density optical recording medium (hereinafter referred to as “HD-DVD”), such as a Blu-ray Disc (hereafter referred to as “BD”), is under development for writing and storing high definition video and audio data. Currently, global standard technical specifications of the Blu-ray Disc (BD), which is known to be the next generation technology, are under establishment as a next generation optical recording solution that is able to have a data significantly surpassing the conventional DVD, along with many other digital apparatuses.

Accordingly, optical reproducing apparatuses having the Blu-ray Disc (BD) standards applied thereto are also being developed. However, since the Blu-ray Disc (BD) standards are yet to be completed, there have been many difficulties in developing a complete optical reproducing apparatus. Particularly, in order to effectively reproduce the data from the Blu-ray Disc (BD), not only should the main AV data as well as various data required for a user's convenience, such as subtitle information as the supplementary data related to the main AV data, be provided, but also managing information for reproducing the main data and the subtitle data recorded in the optical disc should be systemized and provided.

However, in the present Blu-ray Disc (BD) standards, since the standards of the supplementary data, particularly the subtitle stream file, are not completely consolidated, there are many restrictions in the full-scale development of a Blu-ray Disc (BD) basis optical reproducing apparatus. And, such restrictions cause problems in providing the supplementary data such as subtitles to the user.

### SUMMARY OF THE INVENTION

Accordingly, the present invention is directed to a recording medium and method and apparatus for reproducing and recording text subtitle streams that substantially obviate one or more problems due to limitations and disadvantages of the related art.

An object of the present invention is to provide a method of creating a set of style information when recording text subtitle streams within the recording medium according to the present invention.

Another object of the present invention is to provide a method and apparatus for reproducing text subtitle streams that can effectively reproduce the above-described text subtitle stream according to the present invention.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a recording medium for reproducing text subtitle streams includes a data area storing at least one text subtitle stream, each text subtitle stream including a dialog style segment defining a set of region styles and at least one dialog presentation segment, each dialog presentation segment containing at least one region of dialog text, each region of dialog text including link information configured to link the each region of dialog text to one of the set of region styles defined in the dialog style segment. Herein, the link information may be a region style identification uniquely identifying the region style linked to the each region of dialog text.

In another aspect of the present invention, a method for reproducing text subtitle streams includes reading a text subtitle stream recorded on a recording medium, the text subtitle stream including a dialog style segment defining a set of region styles and a plurality of dialog presentation segments, each dialog presentation segment containing at least one region of dialog text, reading a region style identification included in each region of dialog text, the region style identification uniquely identifying one of the set of region styles defined in the dialog style segment, and decoding each region of dialog text by applying the region style identified by the region style identification.

In another aspect of the present invention, an apparatus for reproducing text subtitle streams includes a buffer configured to preload a text subtitle stream recorded on a recording medium, the preloaded text subtitle stream including a dialog style segment defining a set of region styles and a plurality of dialog presentation segments, each dialog presentation segment containing at least one region of dialog text, and a text subtitle decoder configured to read a region style identification included each region of dialog text, the region style identification uniquely identifying one of the set of region styles, the text subtitle decoder being further configured to decode each region of dialog text by applying the identified region style.

In another aspect of the present invention, a method for reproducing text subtitle streams includes reproducing at least one text subtitle stream recorded on a recording medium, each text subtitle stream including a dialog style segment defining a set of region styles and at least one dialog presentation segment, each dialog presentation segment containing at least one region of dialog text, each region of dialog text including link information configured to link the each region of dialog text to one of the set of region styles defined in the dialog style segment.

In another aspect of the present invention, an apparatus for reproducing text subtitle streams includes a driver configured to drive an optical reproducing device to reproduce data recorded on a recording medium, and a controller configured to control the driver to reproduce at least one text subtitle stream recorded on the recording medium, each text subtitle stream including a dialog style segment defining a set of region styles and at least one dialog presentation segment, each dialog presentation segment containing at least one region of dialog text, each region of dialog text including link information configured to link the each region of dialog text to one of the set of region styles defined in the dialog style segment.

In another aspect of the present invention, a method of recording text subtitle streams includes recording at least one text subtitle stream on a recording medium, each text subtitle stream including a dialog style segment defining a set of region styles and at least one dialog presentation segment, each dialog presentation segment containing at least one region of dialog text, each region of dialog text including link information configured to link the each region of dialog text to one of the set of region styles defined in the dialog style segment.

In a further aspect of the present invention, an apparatus for recording text subtitle streams includes a driver configured to drive an optical recording device to record data on a recording medium, a controller for controlling the driver to record at least one text subtitle stream on the recording medium, each text subtitle stream including a dialog style segment defining a set of region styles and at least one dialog presentation segment, each dialog presentation segment containing at least one region of dialog text, each region of dialog text including link information configured to link the each region of dialog text to one of the set of region styles defined in the dialog style segment.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates a structure of the data files recorded in an optical disc according to the present invention;

FIG. 2 illustrates data storage areas of the optical disc according to the present invention;

FIG. 3 illustrates a text subtitle and a main image presented on a display screen according to the present invention;

FIG. 4 illustrates a schematic diagram illustrating reproduction control of a main AV clip and text subtitle clips according to the present invention;

FIG. 5A illustrates a dialog presented on a display screen according to the present invention;

FIG. 5B illustrates regions of a dialog presented on a display screen according to the present invention;

FIG. 5C illustrates style information for regions of a dialog according to the present invention;

FIG. 6 illustrates the structure of a text subtitle stream file according to the present invention;

FIG. 7 illustrates an application of a set of style information to the structure of the text subtitle stream file according to the present invention;

FIG. 8 illustrates a syntax of the text subtitle stream file according to the present invention;

FIGS. 9A to 9D illustrate another example of syntax of the text subtitle stream file according to the present invention;

FIGS. 10A and 10B illustrate another example of syntax of the text subtitle stream file according to the present invention; and

FIG. 11 illustrates an optical recording and/or reproducing apparatus including a reproduction of the text subtitle stream file according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

In this detailed description, “recording medium” refers to all types of medium that can record data and broadly includes all types of medium regardless of the recording method, such as an optical disc, a magnetic tape, and so on. Hereinafter, for simplicity of the description of the present invention, the optical disc and, more specifically, the “Blu-ray disc (BD)” will be given as an example of the recording medium proposed herein. However, it will be apparent that the spirit or scope of the present invention may be equally applied to other types of recording medium.

In this detailed description, “main data” represent audio/video (AV) data that belong to a title (e.g., a movie title) recorded in an optical disc by an author. In general, the AV data are recorded in MPEG2 format and are often called AV streams or main AV streams. In addition, “supplementary data” represent all other data required for reproducing the main data, examples of which are text subtitle streams, interactive graphic streams, presentation graphic streams, and supplementary audio streams (e.g., for a browsable slideshow). These supplementary data streams may be recorded in MPEG2 format or in any other data format. They could be multiplexed with the AV streams or could exist as independent data files within the optical disc.

A “subtitle” represents caption information corresponding to video (image) data being reproduced, and it may be represented in a predetermined language. For example, when a user selects an option for viewing one of a plurality of subtitles represented in various languages while viewing images on a display screen, the caption information corresponding to the selected subtitle is displayed on a predetermined portion of the display screen. If the displayed caption information is text data (e.g., characters), the selected subtitle is often called a “text subtitle”. According to one aspect of the present invention, a plurality of text subtitle streams in MPEG2 format may be recorded in an optical disc, and they may exist as a plurality of independent stream files. Each “text subtitle stream file” is created and recorded within an optical disc. And, the purpose of the present invention is to provide a method and apparatus for reproducing the recorded text subtitle stream file.

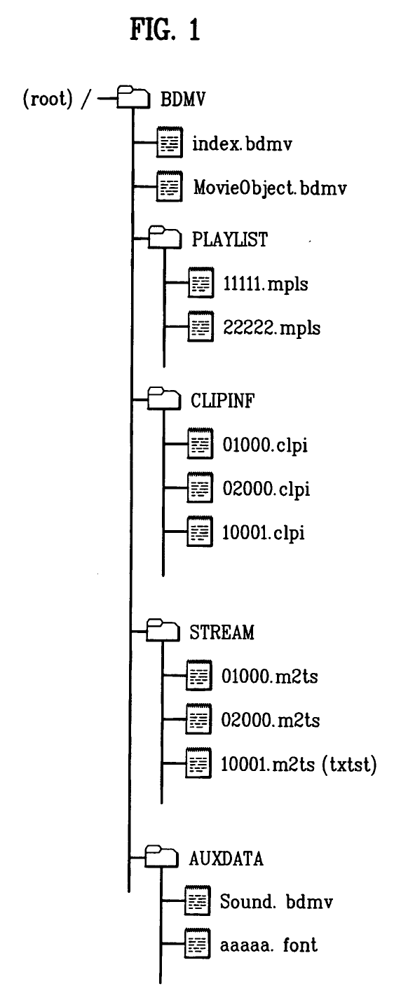

FIG. 1 illustrates a file structure of the data files recorded in a Blu-ray disc (hereinafter referred to as “BD”) according to the present invention. Referring to FIG. 1, at least one BD directory (BDMV) is included in a root directory (root). Each BD directory includes an index file (index.bdmv) and an object file (MovieObject.bdmv), which are used for interacting with one or more users. For example, the index file may contain data representing an index table having a plurality of selectable menus and movie titles. Each BD directory further includes four file directories that include audio/video (AV) data to be reproduced and various data required for reproduction of the AV data.

The file directories included in each BD directory are a stream directory (STREAM), a clip information directory (CLIPINF), a playlist directory (PLAYLIST), and an auxiliary data directory (AUX DATA). First of all, the stream directory (STREAM) includes audio/video (AV) stream files having a particular data format. For example, the AV stream files may be in the form of MPEG2 transport packets and be named as “*.m2ts”, as shown in FIG. 1. The stream directory may further include one or more text subtitle stream files, where each text subtitle stream file includes text (e.g., characters) data for a text subtitle represented in a particular language and reproduction control information of the text data. The text subtitle stream files exist as independent stream files within the stream directory and may be named as “*.m2ts” or “*.txtst”, as shown in FIG. 1. An AV stream file or text subtitle stream file included in the stream directory is often called a clip stream file.

Next, the clip information directory (CLIPINF) includes clip information files that correspond to the stream files (AV or text subtitle) included in the stream directory, respectively. Each clip information file contains property and reproduction timing information of a corresponding stream file. For example, a clip information file may include mapping information, in which presentation time stamps (PTS) and source packet numbers (SPN) are in a one-to-one correspondence and are mapped by an entry point map (EPM), depending upon the clip type. Using the mapping information, a particular location of a stream file may be determined from a set of timing information (In-Time and Out-Time) provided by a PlayItem or SubPlayltem, which will be discussed later in more details. In the industry standard, each pair of a stream file and its corresponding clip information file is designated as a clip. For example, 01000.clpi included in CLIPINF includes property and reproduction timing information of 01000.m2ts included in STREAM, and 01000.clpi and 01000.m2ts form a clip.

Referring back to FIG. 1, the playlist directory (PLAYLIST) includes one or more PlayList files (*.mpls), where each PlayList file includes at least one PlayItem that designates at least one main AV clip and the reproduction time of the main AV clip. More specifically, a PlayItem contains information designating In-Time and Out-Time, which represent reproduction begin and end times for a main AV clip designated by Clip_Information_File_Name within the PlayItem. Therefore, a PlayList file represents the basic reproduction control information for one or more main AV clips. In addition, the PlayList file may further include a SubPlayltem, which represents the basic reproduction control information for a text subtitle stream file. When a SubPlayltem is included in a PlayList file to reproduce one or more text subtitle stream files, the SubPlayltem is synchronized with the PlayItem(s). On the other hand, when the SubPlayltem is used to reproduce a browsable slideshow, it may not be synchronized with the PlayItem(s). According to the present invention, the main fuiction of a SubPlayltem is to control reproduction of one or more text subtitle stream files.

Lastly, the auxiliary data directory (AUX DATA) may include supplementary data stream files, examples of which are font files (e.g., aaaaa.font or aaaaa.otf), pop-up menu files (not shown), and sound files (e.g., Sound.bdmv) for generating click sound. The text subtitle stream files mentioned earlier may be included in the auxiliary data directory instead of the stream directory.

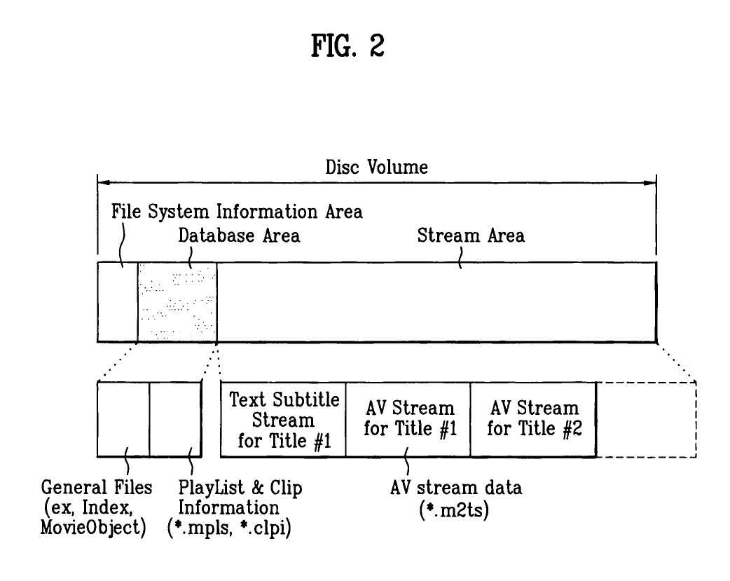

FIG. 2 illustrates data storage areas of an optical disc according to the present invention. Referring to FIG. 2, the optical disc includes a file system information area occupying the inmost portion of the disc volume, a stream area occupying the outmost portion of the disc volume, and a database area occupied between the file system information area and the stream area. In the file system information area, system information for managing the entire data files shown in FIG. 1 is stored. Next, main data and supplementary data (i.e., AV streams and one or more text subtitle streams) are stored in the stream area. The main data may include audio data, video data, and graphic data. And, the supplementary data (i.e., the text subtitle) is independently stored in the stream area without being multiplexed with the main data. The general files, PlayList files, and clip information files shown in FIG. 1 are stored in the database area of the disc volume. As discussed above, the general files include an index file and an object file, and the PlayList files and clip information files include information required to reproduce the AV streams and the text subtitle streams stored in the stream area. Using the information stored in the database area and/or stream area, a user is able to select a specific playback mode and to reproduce the main AV and text subtitle streams in the selected playback mode.

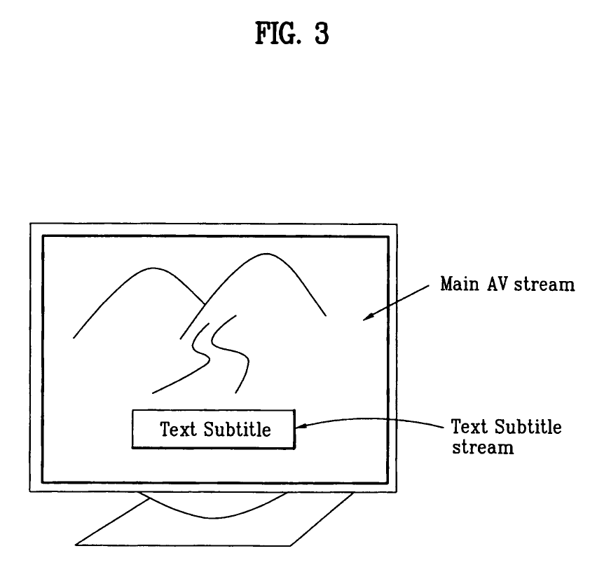

Hereinafter, the structure of the text subtitle stream file according to the present invention will be described in detail. First of all, the control information for reproducing the text subtitle stream will be newly defined. Then, the detailed description of the method of creating the text stream file including the newly defined control information, and the method and apparatus for reproducing the text subtitle stream so as to reproduce the recorded stream file will follow. FIG. 3 illustrates a text subtitle and a main image presented on a display screen according to the present invention. The main image and the text subtitle are simultaneously displayed on the display screen when a main AV stream and a corresponding text subtitle stream are reproduced in synchronization.

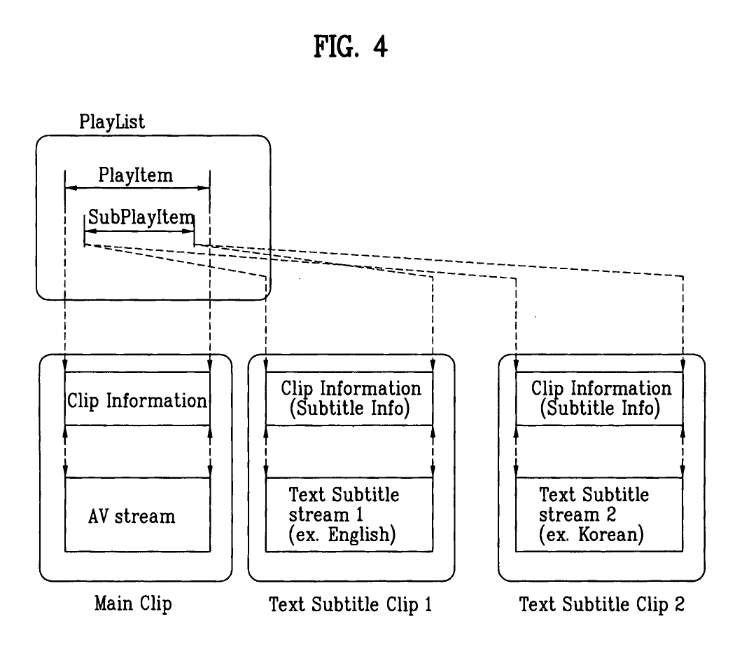

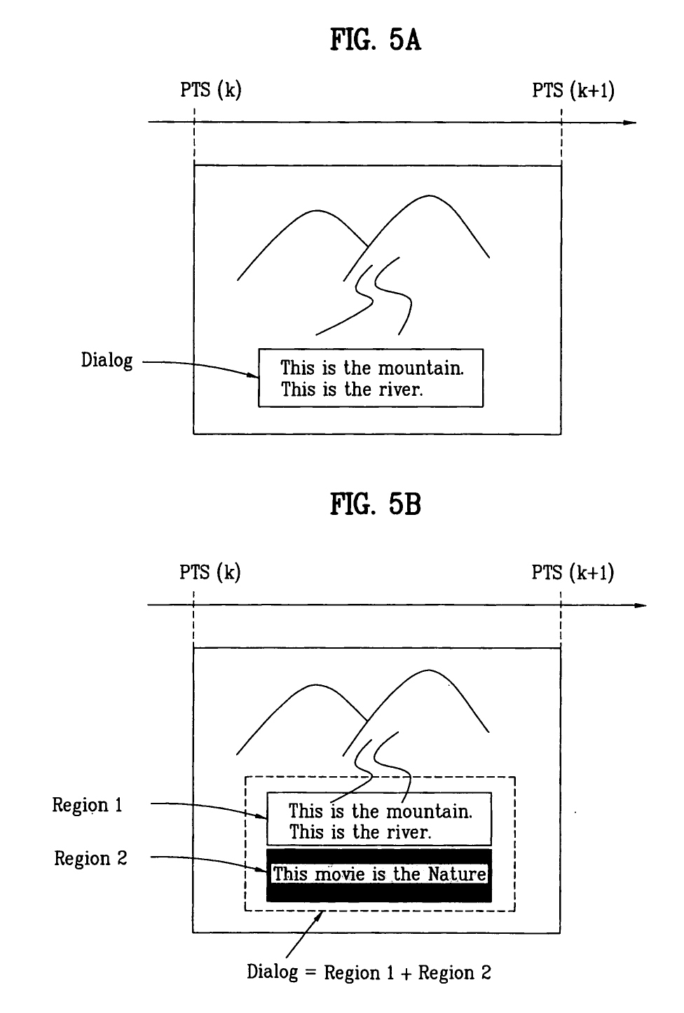

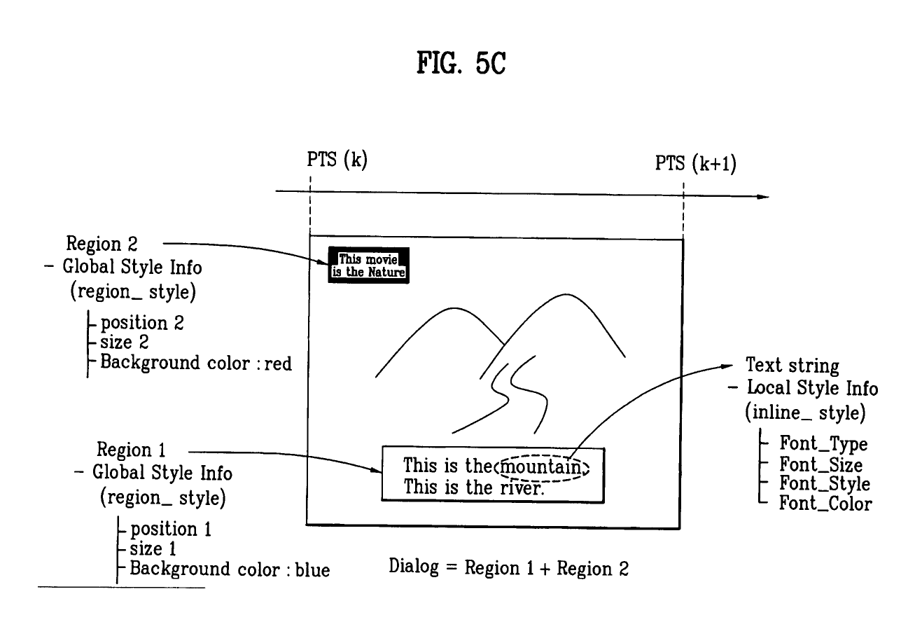

FIG. 4 is a schematic diagram illustrating reproduction control of a main AV clip and text subtitle clips according to the present invention. Referring to FIG. 4, a PlayList file includes at least one PlayItem controlling reproduction of at least one main AV clip and a SubPlayItem controlling reproduction of a plurality of text subtitle clips. One of text subtitle clip 1 and text subtitle clip 2, shown in FIG. 4, for English and Korean text subtitles may be synchronized with the main AV clip such that a main image and a corresponding text subtitle are displayed on a display screen simultaneously at a particular presentation time. In order to display the text subtitle on the display screen, display control information (e.g., position and size information) and presentation time information, examples of which are illustrated in FIG. 5A to FIG. 5C, are required.

FIG. 5A illustrates a dialog presented on a display screen according to the present invention. A dialog represents entire text subtitle data displayed on a display screen during a given presentation time. In general, presentation times of the dialog may be represented in presentation time stamps (PTS). For example, presentation of the dialog shown in FIG. 5A starts at PTS (k) and ends at PTS (k+1). Therefore, the dialog shown in FIG. 5A represents an entire unit of text subtitle data which are displayed on the display screen between PTS (k) and PTS (k+1). A dialog includes a maximum of 100 character codes in one text subtitle.

In addition, FIG. 5B illustrates regions of a dialog according to the present invention. A region represents a divided portion of text subtitle data (dialog) displayed on a display screen during a given presentation time. In other words, a dialog includes at least one region, and each region may include at least one line of subtitle text. The entire text subtitle data representing a region may be displayed on the display screen according to a region style (global style) assigned to the region. The maximum number of regions included in a dialog should be determined based on a desired decoding rate of the subtitle data because the greater number of regions generally results in a lower decoding ratio. For example, the maximum number of regions for a dialog may be limited to two in order to achieve a reasonably high decoding rate.

FIG. 5C illustrates style information for regions of a dialog according to the present invention. Style information represents information defining properties required for displaying at least a portion of a region included in a dialog. Some of the examples of the style information are position, region size, background color, text alignment, text flow information, and many others. The style information may be classified into region style information (global style information) and inline style information (local style information).

Region style information defines a region style (global style) which is applied to an entire region of a dialog. For example, the region style information may contain at least one of a region position, region size, font color, background color, text flow, text alignment, line space, font name, font style, and font size of the region. For example, two different region styles are applied to region 1 and region 2, as shown in FIG. 5C. A region style with position 1, size 1, and blue background color is applied to Region 1, and a different region style with position 2, size 2, and red background color is applied to Region 2.

On the other hand, inline style information defines an inline style (local style) which is applied to a particular portion of text strings included in a region. For example, the inline style information may contain at least one of a font type, font size, font style, and font color. The particular portion of text strings may be an entire text line within a region or a particular portion of the text line. Referring to FIG. 5C, a particular inline style is applied to the text portion “mountain” included in Region 1. In other words, at least one of the font type, font size, font style, and font color of the particular portion of text strings is different from the remaining portion of the text strings within Region 1.

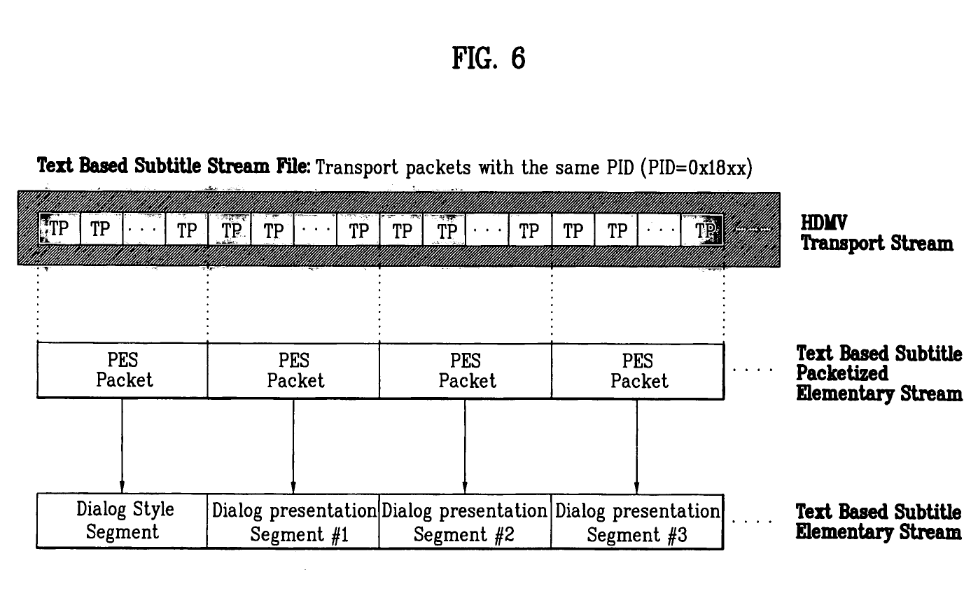

FIG. 6 illustrates a text subtitle stream file (e.g., 10001.m2ts shown in FIG. 1) according to the present invention. The text subtitle stream file may be formed of an MPEG2 transport stream including a plurality of transport packets (TP), all of which have a same packet identifier (e.g., PID=0x18xx). When a disc player receives many input streams including a particular text subtitle stream, it finds all the transport packets that belong to the text subtitle stream using their PIDs. Referring to FIG. 6, each sub-set of transport packets form a packet elementary stream (PES) packet. One of the PES packets shown in FIG. 6 corresponds to a dialog style segment (DSS) defining a group of region styles. All the remaining PES packets after the second PES packet correspond to dialog presentation segments (DPSs)

In the above-described text subtitle stream structure of FIG. 6, each of the dialog information shown in FIGS. 5A to 5C represent a dialog presentation segment (DPS). And, the style information included in the dialog information represents a set of information that links any one of the plurality of region style sets defined in the dialog style segment (DSS), which can also be referred to as “region_style_id”, and inline styles. A standardized limited number of region style sets is recorded in the dialog style segment (DSS). For example, a maximum of 60 sets of specific style information is recorded, each of which is described by a region_style_id.

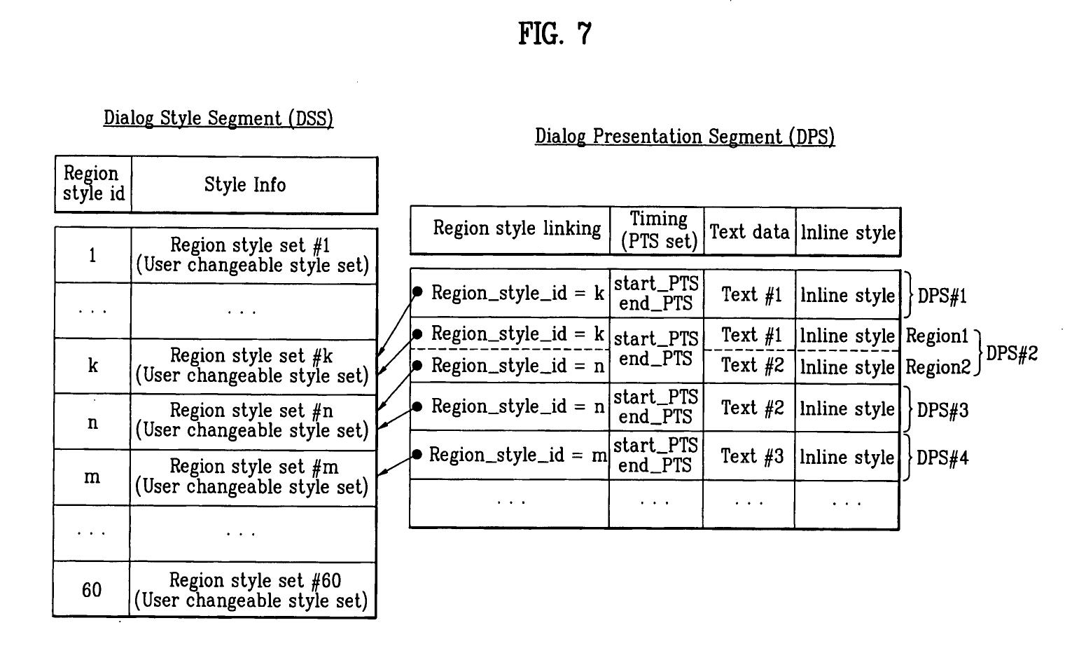

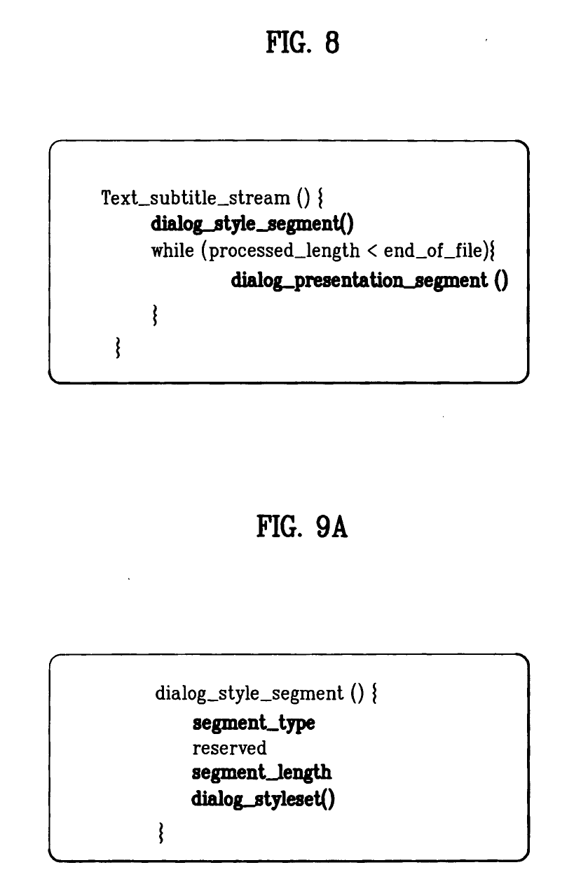

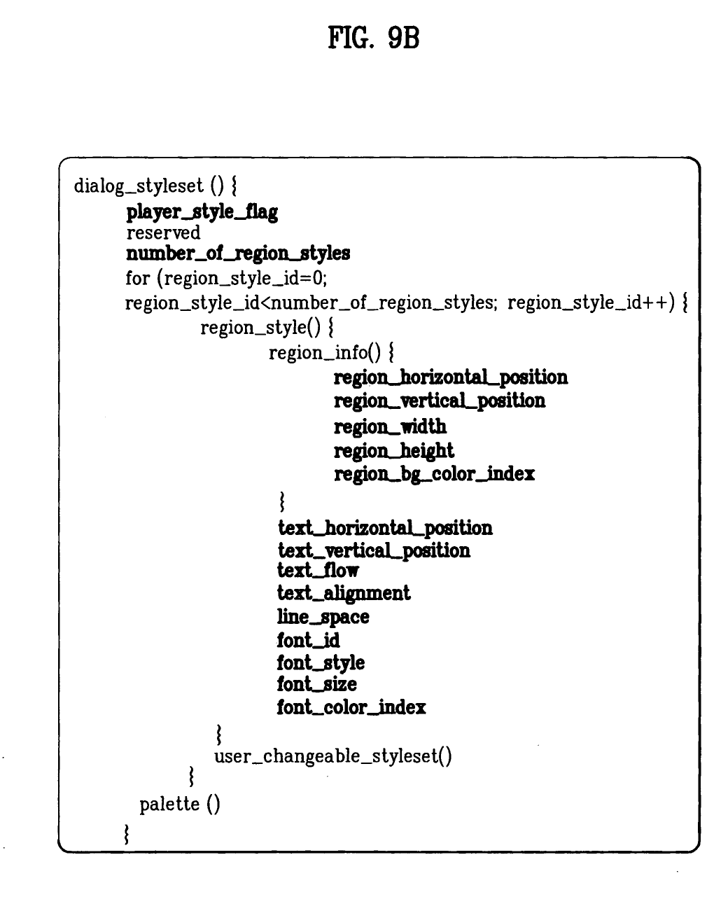

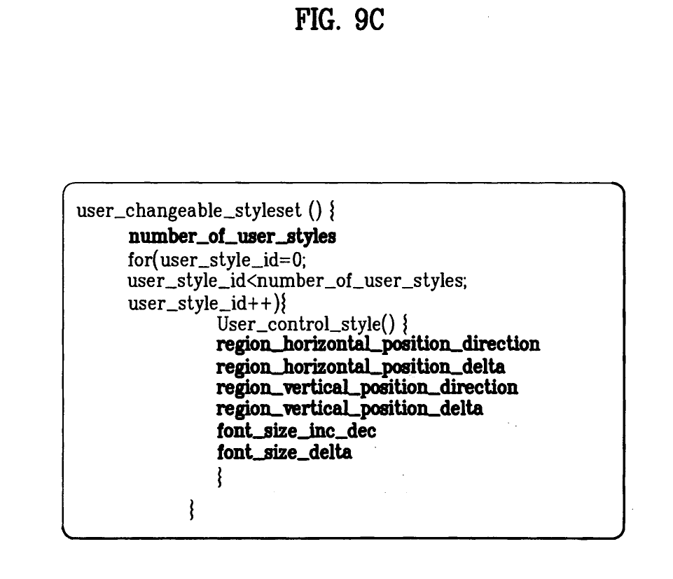

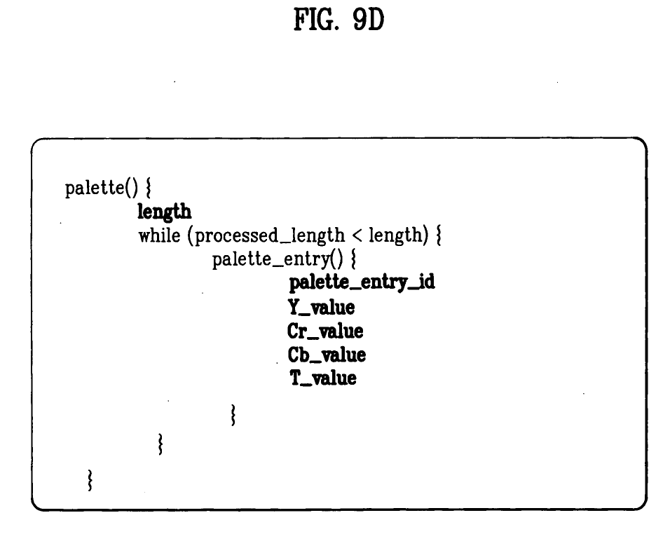

FIG. 7 illustrates structures of the dialog style segment (DSS) recorded in the text subtitle stream, and of the dialog presentation segment (DPS). Accordingly, a detailed syntax of the text subtitle stream will be described in a later process with reference to FIG. 8. More specifically, the dialog style segment (DSS) includes a maximum of 60 sets of region style is recorded therein, each of which is described by a region_style_id. A region style set, which includes diverse region style information, and a user changeable style set are recorded in each region_style_id. Herein, detailed contents of the region style information will be described in FIG. 9B, and detailed contents of the user changeable style information will be described in FIG. 9C.

Furthermore, the dialog presentation segment (DPS) includes text data and timing information indicating the presentation time of the text data (i.e., PTS set). The dialog presentation segment (DPS) also includes information linking any one of the style information for each region and the specific region style information included in the above-described dialog style. Therefore, DPS #1 is formed of a single region, and the region style applied to the text data (Text data #1) is applied to region_style_id=k included in the dialog presentation segment (DPS). DPS #2 is formed of two regions, and the region style applied to the text data (Text data #1) of the first region is applied to region_style_id=k included in the dialog presentation segment (DPS). And, the region style applied to the text data (Text data #2) of the second region is applied to region_style_id=n included in the dialog presentation segment (DPS). Similarly, DPS #3 and DPS #4 applies region_style_id=n and region_style_id=m to each corresponding style information within the dialog presentation segment (DPS), respectively.

Accordingly, when two regions exist within a single dialog, such as in DPS #2, each of the region_style_id applied to each region should be given a different value. More specifically, as described above, region_style_id=k is applied to the first region within DPS #2, and region_style_id=n is applied to the second region within DPS #2, thereby respectively applying different region style sets. When an identical region_style_id is applied to each region, then the two regions are overlapped on the screen, which causes difficulty in displaying the text subtitle. Meanwhile, the style information being linked by the region_style_id is identically applied to all of the text data within the corresponding region (i.e., global style information). However, the inline style information, which is a set of local style information being applied only to the corresponding text string, is newly defined and applied when the style information of a specific text string within the text data is to be modified.

The syntax structure of the above-described dialog style segment (DSS) and the dialog presentation segment (DPS) will now be described in detail with reference to FIGS. 8 to 10B. FIG. 8 illustrates a syntax of the text subtitle stream (Text_subtitle_stream( )) according to the present invention. Referring to FIG. 8, the Text_subtitle_stream( ) includes a dialog_style_segment( ) syntax and a dialog_presentation_segment( ) syntax. More specifically, the dialog_style_segment( ) syntax corresponds to a single dialog style segment (DSS) defining the style information set, and the dialog_presentation_segment( ) syntax corresponds to a plurality of dialog presentation segments (DPS) having the actual dialog information recorded therein.

FIGS. 9A to 9C illustrate a detailed structure of the dialog_style_segment( ), which represent the dialog style segment (DSS). More specifically, FIG. 9A illustrates the overall structure of the dialog_style_segment( ), wherein a dialog_style set( ) defining diverse style information sets that are applied in the dialog is defined. FIG. 9B illustrates a dialog_style set( ) according to the present invention, which is defined in the dialog_style_segment( ). Apart from the region_styles, the dialog_style_set( ) includes a Player_style_flag, a user_changeable_style set( ), and a palette( ). The Player_style_flag indicates whether change in style information by the player is authorized. Also, the user_changeable_style set( ) defines the range of change in style information by the player, and the palette( ) indicates color information.

The region style information (region styles) represents Global style information defined for each region, as described above. A region_style_id is assigned to each region, and a style information set corresponding to the specific region_style_id is defined. Therefore, when reproducing a dialog by recording the region_style_id, which is applied to the corresponding dialog, within the dialog presentation segment (DPS), style information set values defined by identical region_style_id within the dialog_style set( ) are applied, so as to reproduce the dialog. Accordingly, individual style information included in the style information set provided to each region_style_id will now be described.

Herein, region_horizontal_position, region_vertical_position, region_width, and region_height are provided as information for defining the position and size of a corresponding region within the screen. And, region_bg_color_index information deciding a background color of the corresponding region is also provided. In addition, as information defining an original (or starting) position of the text within the corresponding region, a text_horizontal_position and a text_vertical_position are provided. Also, a text_flow defining the direction of the text (e.g., left→right, right→left, up→down), and a text_alignment defining the alignment direction of the text (e.g., left, center, right) are provided. More specifically, when a plurality of regions are included in a specific dialog, the text_flow of each region included in the corresponding dialog is defined to have an identical text_flow value, so as to prevent users from viewing disturbed images.

Furthermore, a line_space designating space between each line within the region is provided as individual style information included in the style information set. And, a font_type, a font-size, and a font_color_index are provided as font information for actual font information. Meanwhile, the Player_style_flag recorded within the dialog_style set( ) indicates whether an author may apply the style information provided to the player. For example, when Player_style_flag=1b, as well as the style information defined in the dialog_style set( ) recorded in a disc, the player is authorized to reproduce the text subtitle stream by applying the style information provided within the player itself. On the other hand, when Player_style_flag=0b, only usage of the style information defined in the dialog_style set( ) recorded within the disc is authorized.

FIG. 9C illustrates the user_changeable_style set( ) according to the present invention, which is defined in dialog_style set( ). The user_changeable_style set( ) pre-defines the types of style information that can be changed by the user and the range of change, and the user_changeable_style set( ) is used for easily changing the style information of the text subtitle data. However, when the user is enabled to change all style information, which are described in FIG. 9B, the user may more confused. Therefore, in the present invention, the style information of only the font_size, the region_horizontal_position, and the region_vertical_position may be changed. And, accordingly, variation in the text position and the line space, which may be changed in accordance with the font_size, is also defined in the user_changeable_style set( ). More specifically, the user_changeable_style set( ) is defined for each region_style_id. For example, a maximum of 25 user_style_id within a specific region_style_id=k may be defined in the user_changeable_style set( ).

Also, each user_style_id includes region_horizontal_position_direction and region_vertical_position_direction information, which designate the direction of the changed position of each of the changeable region_horizontal_position and region_vertical_position. Each user_style_id also includes region_horizontal_position_delta and region_vertical_position_delta information for designating a single position movement unit in each direction as a pixel unit. More specifically, for example, when region_horizontal_position_direction=0, the position of the region is moved to a right direction. And, when region_horizontal_position_direction=1, the position of the region is moved to a left direction. Also, when region_vertical_position_direction=0, the position of the region is moved to a downward direction. Finally, when region_vertical_position_direction=1, the position of the region is moved to an upward direction.

Furthermore, each user_style_id includes font_size_inc_dec information, which designates the changing direction each of the changeable font_size, and font_size_delta information for designating a single position movement unit in each direction as a pixel unit. More specifically, for example, font_size_inc_dec=0 represents an increasing direction of the font_size, and font_size_inc_dec=1 represents a decreasing direction of the font_size.

Accordingly, the characteristics of the user_changeable_style set( ) according to the present invention will now be described as follows. An identical number of user_control_style( ) is defined in all region_style( ) that are included in the dialog style segment (DSS). Accordingly, the number of user_control_style that can be applied to all of the dialog presentation segments (DPS) is also identical. Further, each user_control_style( ) is represented by a different user_style_id, and when the user selects a random user_id_style, an identical order of the user_control_style( ) is applied to all region_style( ). In addition, a combination of all changeable styles is defined in a single user_control_style( ). More specifically, the region_position, and the font_size are defined simultaneously, instead of being defined separately. Finally, each of the direction (*_direction) and the indication of increase or decrease (*_inc_dec) is recorded independently regardless of each position movement unit (*_delta). More specifically, by defining only the position movement unit (*_delta), a final value of the actually changed style information (or style value) may be obtained by adding the position movement unit (*_delta) to the value defined in the region_style( ).

FIG. 9D illustrates palette information (palette( )) according to the present invention, which is defined in the dialog_style set( ). The palette( ) provides color changing information of the text subtitle data recorded within the dialog. Herein, the palette( ) includes a specific brightness value (Y_value), a specific color value (Cr_value, Cb_value), and a specific T_value, which designates the transparency of the text data, for each palette_entry_id. Therefore, a plurality palette_entry_ids are recorded in a single palette( ).

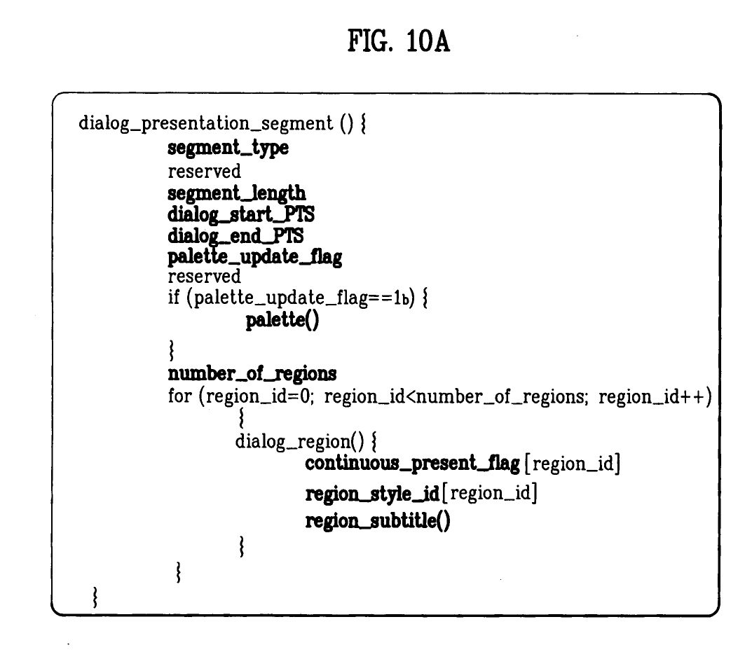

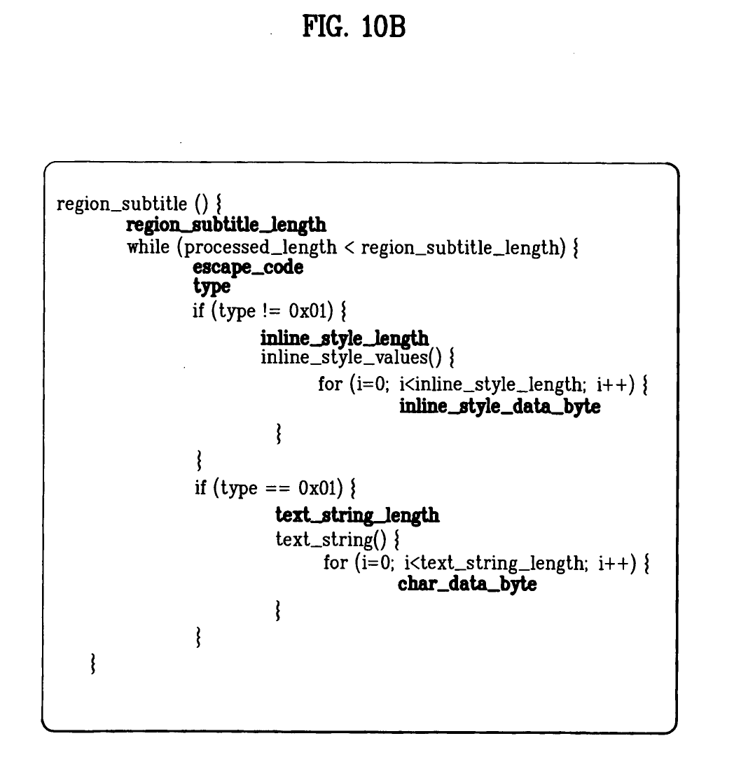

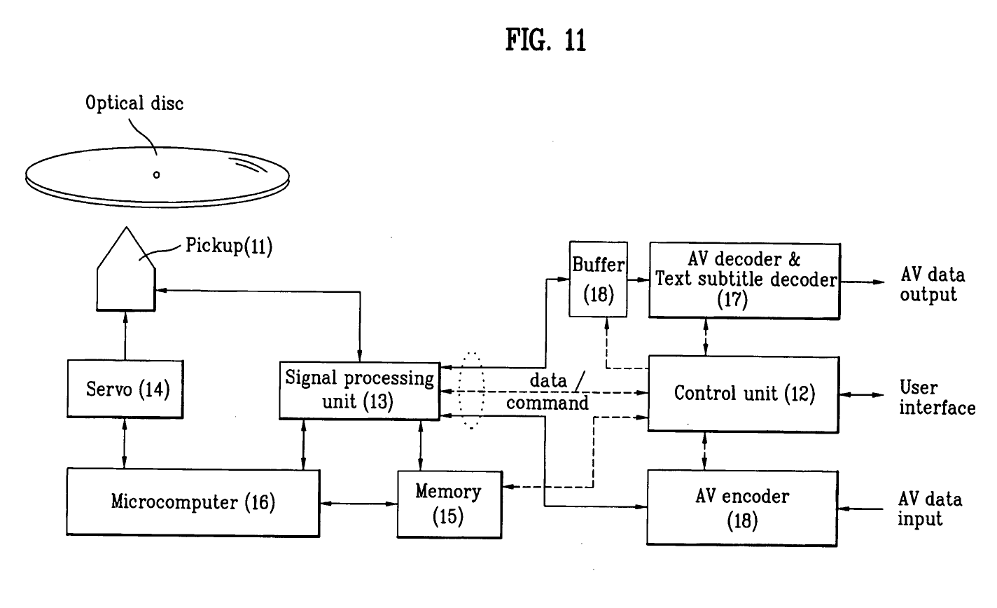

FIGS. 10A and 10B illustrate a detailed structure of the dialog_presentation_segment( ), which represent the dialog presentation segment (DPS) according to the present invention. FIG. 10A illustrates the overall structure of the dialog_presentation_segment( ), wherein a dialog_start_PTS and a dialog_end_PTS are defined. The dialog_start_PTS and the dialog_end_PTS designate the presentation time of the corresponding dialog. Then, the dialog_presentation_segment( ) includes a palette_update_flag, which indicates a change of information within the corresponding dialog. When palette_update_flag=1b, a change (or update) of color occurs. And, the palette( ) information defining the newly changed color is recorded separately.

Subsequently, a dialog_region( ) that defines the region information is recorded in the dialog_presentation_segrnent( ). In the present invention, a maximum of two regions is provided within a single dialog, and therefore, dialog_region( ) information is provided to each region. The dialog_region( ) includes region_style_id information and continuous_present_flag information. The region_style_id information designates any one of the region styles, as shown in FIG. 9B, and the continuous_present_flag information identifies whether to perform a seamless reproduction with the previous dialog region. Further, text data and region_subtitle( ) information are also included in the dialog_region( ). The text data is included in the actual corresponding region, and the region_subtitle( ) information defines the local style information.

FIG. 10B illustrates a set of region_subtitle( ) information defined in the dialog_region( ). The region_subtitle( ) consists of a text string and inline style information applied to the text string, which are formed in pairs (or groups). In other words, when the type within the region_subtitle( ) is type=0x01, the type represents the text string, and therefore, a character code (color_data_byte) is recorded within the text_string( ). In addition, when the type within the region_subtitle( ) is not type=0x01, the type represents the inline style information. For example, type=0x02 represents a change in the Font set, and so a font ID value designated by the corresponding Cliplnfo is recorded in the inline_style_value( ), and type=0x03 represent a change in the Font style, and so a corresponding font style value is recorded in the inline_style_value( ). Also, type=0x04 represents a change in the Font size, and a corresponding font size value is recorded in the inline_style_value( ), and type=0x05 represents a change in the Font color, and therefore, an index value designated by the corresponding palette is recorded in the inline_style_value( ). Finally, type=0x0A represents a line break in the present invention. For example, among the text data corresponding to region #1, as described in FIG. 5C, the text portion “mountain” is written as a text_string (e.g., text_string=mountain), whereas the local information is recorded as inline_style type=0x04 (i.e., change in Font size). Subsequently, when inline_style_value( )=xxx, the font_size of the corresponding text_string=mountain may be reproduced to have the desired value (xxx).

FIG. 11 illustrates a detailed view of an optical recording and/or reproducing apparatus 10 according to the present invention, including the reproduction of the text subtitle data. The optical recording and/or reproducing apparatus 10 basically includes a pick-up unit 11 for reproducing main data, text subtitle stream and corresponding reproduction control information recorded on the optical disc, a servo 14 controlling the operations of the pick-up unit 11, a signal processor 13 either recovering the reproduction signal received from the pick-up unit 11 to a desired signal value, or modulating a signal to be recorded to an optical disc recordable signal and transmitting the modulated signal, and a microcomputer 16 controlling the above operations.

In addition, an AV decoder or text subtitle (Text ST) decoder 17 performs final decoding of output data depending upon the controls of the controller 12. And, in order to perform the function of recording a signal on the optical disc, an AV encoder 18 converts an input signal into a signal of a specific format (e.g., an MPEG-2 transport stream) depending upon the controls of the controller 12 and, then, provides the converted signal to the signal processor 13.

A buffer 18 is used for preloading and storing the text subtitle stream in advance, in order to decode the text subtitle stream according to the present invention. The controller 12 controls the operations of the optical recording and/or reproducing apparatus. And, when the user inputs command requesting a text subtitle of a specific language to be displayed. Then, the corresponding text subtitle stream is preloaded and stored in the buffer 18. Subsequently, among the text subtitle stream data that is preloaded and stored in the buffer 18, the controller 12 refers to the above-described dialog information, region information, style information, and so on, and controls the text subtitle decoder 17 so that the actual text data are displayed with a specific size and at a specific position on the screen. More specifically, the text subtitle decoder 17 decodes the dialog presentation segments (DPS) recorded in the text subtitle stream, which is preloaded within the buffer 18. However, the text subtitle stream is reproduced by using the specific region style information within the above-described dialog presentation segment (DPS), which is designated by the region_style_id recorded in the dialog presentation segment (DPS).

As described above, the recording medium and method and apparatus for reproducing and recording text subtitle streams have the following advantages. Text subtitle streams may be recorded within the optical disc as standardized information, thereby enabling an efficient reproduction of the recorded text subtitle stream file.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A recording medium for storing a data structure, the data structure comprising:
at least one text subtitle stream, each text subtitle stream including style segment defining region styles and at least one presentation segment, the presentation segment containing two regions, each of the two regions including independent link information configured to link the corresponding region to distinct region style defined in the style segment.

2. The recording medium of claim 1, wherein the link information is region style identification specifying the region style linked to each region.

3. The recording medium of claim 1, wherein the region further includes at least one text string and defines an inline style for each text string, the inline style being applied to at least a portion of each text string.

4. The recording medium of claim 1, wherein the region style comprises a plurality of display properties including font-related display properties required for displaying text data in the text subtitle stream.

5. The recording medium of claim 4, wherein the plurality of display properties include at least one of a region position, a region size, a region background color, a text position, a text flow, a text alignment, a line space, a font identification, a font style, a font size, and a font color.

6. The recording medium of claim 5, wherein the region position specifies at least one of a horizontal position and a vertical position of the region within the display screen.

7. The recording medium of claim 5, wherein the region size specifies at least one of a width and height of the region.

8. The recording medium of claim 5, wherein the text flow specifies at least one of a character progression and a line progression of the text data within the region.

9. The recording medium of claim 8, wherein the text flows corresponding to each of the regions have the same value.

10. The method of claim 1, wherein each presentation segment further contains presentation time information indicating presentation start and end times of the two regions.

11. A method for reproducing text subtitle streams, the method comprising:
decoding a text subtitle stream, each text subtitle stream including a style segment defining region styles and a plurality of presentation segments, at least one presentation segment containing two regions, each of the two regions including independent link information configured to link the corresponding region to distinct region style defined in the style segment.

12. The method of claim 11, wherein each presentation segment further contains presentation time information indicating presentation start and end times of the two regions.

13. The method of claim 11, wherein the link information is region style identification specifying the region style linked to each region.

14. The method of claim 11, wherein the region further includes at least one text string and defines an inline style for each text string, the inline style being applied to at least a portion of each text string.

15. The method of claim 11, wherein the region style comprises a plurality of display properties including font-related display properties required for displaying text data in the text subtitle stream.

16. The method of claim 15, wherein the text flow specifies at least one of a character progression and a line progression of the text data within the region.

17. The method of claim 16, wherein the text flows corresponding to each of the two regions have the same value.

18. A method of recording text subtitle streams, the method comprising:
generating style segment defining region styles and at least one presentation segment containing two regions, each of the two regions including independent link information configured to link the corresponding region to distinct region style defined in the style segment;
generating at least one text subtitle stream including the style segment and the presentation segment; and
storing the at least one text subtitle stream on a storing device.

19. The method of claim 18, wherein each presentation segment further contains presentation time information indicating presentation start and end times of the two regions.

20. The method of claim 18, wherein the link information is region style identification specifying the region style linked to each region.

21. The method of claim 18, wherein the region further includes at least one text string and defines an inline style for each text string, the inline style being applied to at least a portion of each text string.

22. The method of claim 18, wherein the region style comprises a plurality of display properties including font-related display properties required for displaying text data in the text subtitle stream.

23. The method of claim 22, wherein the text flow specifies at least one of a character progression and a line progression of the text data within the region.

24. The method of claim 23, wherein the text flows corresponding to each of the two regions have the same value.

25. A method of generating text subtitle streams, the method comprising:
generating style segment defining region styles and at least one presentation segment containing two regions, each of the two regions including independent link information configured to link the corresponding region to distinct region style defined in the style segment; and
generating at least one text subtitle stream including the style segment and the presentation segment.

26. The method of claim 25, the method further comprising:
storing the at least one text subtitle stream on a storage device.

27. An apparatus for reproducing text subtitle streams, the apparatus comprising:
a driver configured to read a data, wherein the data includes a text subtitle stream, each text subtitle stream including a style segment defining region styles and a plurality of presentation segments, at least one presentation segment containing two regions, each of the two regions including independent link information configured to link the corresponding region to distinct region style defined in the style segment.

28. The apparatus of claim 27, wherein each presentation segment further contains presentation time information indicating presentation start and end times of the two regions.

29. The apparatus of claim 27, wherein the link information is region style identification specifying the region style linked to each region.

30. The apparatus of claim 27, wherein the region further includes at least one text string and defines an inline style for each text string, the inline style being applied to at least a portion of each text string.

31. The apparatus of claim 27, wherein the region style comprises a plurality of display properties including font-related display properties required for displaying text data in the text subtitle stream.

32. The apparatus of claim 31, wherein the text flow specifies at least one of a character progression and a line progression of the text data within the region.

33. The apparatus of claim 32, wherein the text flows corresponding to each of the two regions have the same value.

34. An apparatus for reproducing text subtitle streams, the apparatus comprising:
a decoder configured to decode at least one text subtitle, each text subtitle stream including a style segment defining region styles and a plurality of presentation segments, at least one presentation segment containing two regions, each of the two regions including independent link information configured to link the corresponding region to distinct region style defined in the style segment; and
a controller configured to control the decoder to decode the at least one text subtitle stream.

35. The apparatus of claim 34, wherein each presentation segment further contains presentation time information indicating presentation start and end times of the two regions.

36. The apparatus of claim 34, wherein the link information is region style identification specifying the region style linked to each region.

37. The apparatus of claim 34, wherein the region further includes at least one text string and defines an inline style for each text string, the inline style being applied to at least a portion of each text string.

38. The apparatus of claim 34, wherein the region style comprises a plurality of display properties including font-related display properties required for displaying text in the text subtitle stream.

39. The apparatus of claim 38, wherein the text flow specifies at least one of a character progression and a line progression of the text data within the region.

40. The apparatus of claim 39, wherein the text flows corresponding to each of the two regions have the same value.

41. An apparatus for recording text subtitle streams, the apparatus comprising:
a driver; and
a controller configured to generate at least one text subtitle stream, each text subtitle stream including a style segment defining region styles and a plurality of presentation segments, at least one presentation segment containing two regions, each of the two regions including independent link information configured to link the corresponding region to distinct region style defined in the style segment and for controlling the driver to store the at least one text subtitle on a storage device.
